(19) United States
(12) Patent Application Publication
(10) Pub. No.: US 2021/0306252 A1
(43) Pub. Date: Sep. 30, 2021

(54) LOOP AVOIDANCE PROTOCOL

(71) Applicant: HEWLETT PACKARD ENTERPRISE DEVELOPMENT LP, Houston, TX (US)

(72) Inventors: Rajeev Jain, Bangalore (IN); Ayush Shukla, Bangalore (IN)

(21) Appl. No.: 17/184,830

(22) Filed: Feb. 25, 2021

(30) Foreign Application Priority Data
Mar. 25, 2020 (IN) 202041012972

(51) Int. Cl. H04L 12/705; H04L 12/741; H04L 12/717; H04L 12/721; H04L 29/12

(52) U.S. Cl. CPC H04L 45/18; H04L 45/74; H04L 61/6022; H04L 45/566; H04L 45/42

(57) ABSTRACT

Examples disclosed herein relate to a method comprising receiving a control packet originating from a originating network device. The control packet may have a control MAC address identifying the originating network device and the control packet is used for determining a traffic loop in a network including the first network device and the originating network device. The method may include determining, by the first network device, whether the control MAC address of the control packet matches a MAC address of the first network device. Wit is determined that the control MAC address of the control packet matches a MAC address of the first network device, the method may include determining that the match is indicative of the loop and blocking a port of the first network device that the control packet arrived on without blocking any other ports on the first network device. When it is determined that the control MAC address of the control packet does not match the MAC address of the first network device, the method may include transmitting the control packet to a second network device on the network without blocking any port on the first network device that received the control packet.

### BACKGROUND

A network loop may occur when there are multiple paths between devices on a networking. Network loops may cause control packets to be repeatedly transmitted on a network and may have a heavy impact on network performance.

### BRIEF DESCRIPTION OF THE DRAWINGS

Some implementations of the present disclosure are described with respect to the following figures.

FIG. 1A is a block diagram of an example system for a loop avoidance protocol.

FIG. 1B is a block diagram of another example system for a loop avoidance protocol.

FIG. 2 is a flow diagram of an example method for a loop avoidance protocol.

FIG. 3 is a flow diagram of another example method for a loop avoidance protocol.

FIG. 4 is a flow diagram of another example method for a loop avoidance protocol.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An easy loop avoidance and detection method may be desired by network administrators to protect their networking devices from forming a possible loop in their network. A network loop may be especially problematic in large networks as even a small drop in traffic can have huge repercussions. Spanning tree protocol (STP) is widely known protocol being used for the loop avoidance purpose. But STP, has its own demerits along with complex configuration. For example, users may have to configure all network node with required configuration to run STP. Due to these shortcomings, some companies have developed their own loop avoidance techniques. However, many of these protocols have problems of their own. Accordingly, there is a need to develop a solution which and is easier to use and provides very efficient way to detect loops and take necessary action.

The systems and methods described herein describe a new loop avoidance mode. This mode provides the benefits of Rapid Per-VLAN Spanning Tree (RPVST) with many added benefits described below. This mode may use a proprietary MAC as the destination MAC instead of using a standard MAC. This proprietary destination MAC will be unknown to all nodes in network except the node which originated this packet. Hence, nodes other than the originating node will simply flood the RPVST Bridge Protocol Data Unit (BPDU) on all ports. If there is loop, however, then the RPVST BPDU will reach to originator node. If the originator node receives its own packet, an RPVST state machine may move the interface into a Backup/Blocking state to prevent the loop.

The methods and systems disclosed herein describe a loop avoidance mode using a control packet having a unique/vendor specific/proprietary MAC address as a destination MAC address for detecting loops in a network. When the user enables this mode on a switch, the switch will program a CPU rule with this MAC filter. On receiving a control packet, the switch may compare the source MAC (unique/vendor specific/proprietary MAC) of the control packet against the switch's own MAC. If the source MAC doesn't match, the switch will transmit the packets normally. If the source MAC matches, the switch will detect a network loop and close the port that received the control packet to certain types of network traffic. For switches, where the loop protect mode is not enabled, the control packet will be treated as a normal control packet and will be flooded by the switch.

A method for using a loop avoidance protocol may include receiving, at a first network device, a control packet originating from a originating network device, wherein the control packet has a control MAC address identifying the originating network device and the control packet is used for determining a traffic loop in a network including the first network device and the originating network device. The method may also include determining, by the first network device, whether the control MAC address of the control packet matches a MAC address of the first network device. When it is determined that the control MAC address of the control packet matches a MAC address of the first network device, the method may include determining, by the first network device, that the match is indicative of the loop and blocking, by the first network device, a port of the first network device that the control packet arrived on without blocking any other ports on the first network device, wherein no ports are blocked on other devices on the network that received the control packet. When it is determined that the control MAC address of the control packet does not match the MAC address of the first network device, the method may include transmitting the control packet to a second network device on the network without blocking any port on the first network device that received the control packet.

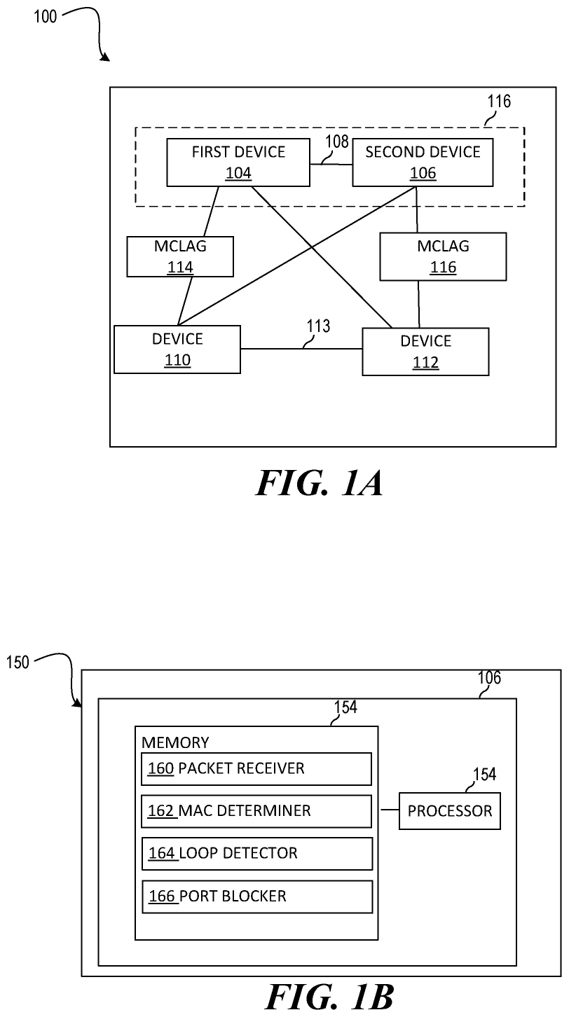

FIG. 1 is a block diagram of an example system 100 where a loop avoidance protocol may be used. The system 100 may include a network 102 having a plurality of devices including first device 104, second device 106, third device 108 and fourth device 110. Third device 108 and forth device 110 may be uplink devices. Although only four devices are shown in system 100, this is for explanatory purposes only and any number of modules may be used in system 100. One or more Virtual Local Area Networks (VLAN) may span the various devices in system 100.

Each of the devices 104-110 may be any number of network devices. For example, a network device may be a network switch. A switch may be a device within a network that forwards data sent by a sender device toward a recipient device (or multiple recipient devices). In some examples, a network device includes a layer 2 switch that forwards control packets (also referred to as data frames or data units) based on layer 2 addresses in the control packets. Examples of layer 2 addresses include Medium Access Control (MAC) addresses. In alternative examples, a switch includes a layer 3 router that forwards control packets based on layer 3 addresses, such as Internet Protocol (IP) addresses in the control packets.

A “packet” or “control packet” can refer to any unit of data that can be conveyed over a network. A packet or control packet may also refer to a frame or data frame, a data unit, a protocol data unit, Bridge Protocol Data Unit (BPDU) and so forth. A switch forwards data (in control packets) between a sender device and a recipient device (or multiple recipient devices) based on forwarding information (or equivalently, “routing information”) accessible by the switch. The forwarding information can include entries that map network addresses (e.g., MAC addresses or IP addresses) and/or ports to respective network paths toward the recipient device(s). One type of control packet is a loop avoidance control packet. The loop avoidance may be a special type of control packet that includes information used by different elements of the system 100 to detect a network loop. The loop avoidance control packet may be a Rapid Per-ULAN Spanning Tree (RPVST) packet.

The information included in the loop avoidance packet may include a MAC address of a device on the network where the packet originated. In some aspects, the system 100 may transmit special loop avoidance control packets that are used for loop detection and avoidance, while in other aspects the loop avoidance and detection information may be included in a normal control packet and/or in a control packet with additional types of information, included but not limited to payload data.

A switch forwards data (in control packets) between a sender device and a recipient device (or multiple recipient devices) based on forwarding information (or equivalently, “routing information”) accessible by the switch. The forwarding information can include entries that map network addresses (e.g., MAC addresses or IP addresses) and/or ports to respective network paths toward the recipient device(s).

Each of the devices 104-110 may be communicatively coupled to one or more of the other devices 104-110 in system 100 via network 108. Link 108 and the various connections between devices 104-110 may be a physical link, such as an Ethernet connection or other physical connection, a wireless connection, a virtual connection, etc.

The combination of the first network device 104 and the second network device 106 may be presented to the user as a single virtualized network device 116. One of the network devices may be a originating network device and the other network device may be a peer device. In the event that the first network device 104 goes down, no traffic may be lost, although the total amount of bandwidth available to the system may be reduced. Moreover, this architecture provides the ability to configure one network device 104 and have the configuration synced to the network device 106. This keeps the network facing elements consistent across management changes to allow for load balancing and high availability in case of failure.

Moreover, the virtualization of the first network device 104 and the second network device 106 as a single virtualized device 116 may allow an LACP (Link Aggregation Control Protocol) group to span more than one network device. In MCLAG (Multi Chassis LAG) based virtualized deployments there are two independent control planes. If the MCLAG pair is connected-up a primary device via an MCLAG with any routing protocol running on top, the network devices may sync their Router-MAC entries between the devices involved so that data traffic can be directly forwarded without sending over an Inter-Switch Link (ISL). System 100 may include MCLAGs 114 and 116.

Multi-Chassis Link Aggregation Group (MCLAG) is a type of LAG with constituent ports that terminate on separate chassis, primarily for the purpose of providing redundancy in the event one of the chassis fails. MCLAG may be used to create a virtual environment when a LAG is created between a pair of two network devices, such as network switches.

Turning now to FIG. 1B, an example network device 150 is shown. The network device may be similar to one or more of the devices illustrated in FIG. 1A, such as the first device 104, second device 106, device 110 and/or device 112. Network device 150 may include a processor 152a and a machine-readable storage medium 152b that may be coupled to each other through a communication link (e.g., a bus). Processor 152a may include a single or multiple Central Processing Units (CPU) or another suitable hardware processor(s), such as a network ASIC. Machine-readable storage medium 152b may store machine readable instructions may executed by processor 152a. Machine-readable storage medium 152b may include any suitable combination of volatile and/or non-volatile memory, such as combinations of Random Access Memory (RAM), Read-Only Memory (ROM), flash memory, and/or other suitable memory.

Machine-readable storage medium 152b stores instructions to be executed by processor 152a including instructions for packet receiver 160, MAC determiner 162, loop detector 164, and port blocker 166.

Processor 152a may execute packet receiver 160 to receive, at a first network device, a control packet originating from a originating network device. The control packet may have a control MAC address identifying the originating network device and the control packet may be used for determining a traffic loop in a network including the first network device and the originating network device. The control MAC address may be associated with a specific vendor, may be proprietary and/or unique. The first network device may be an uplink network switch. The control packet may be a Rapid Per-′ALAN Spanning Tree (RPVST) packet with the control MAC address. The first network device and a second network device may be part of a link aggregation group.

Processor 152a may execute MAC determiner 162 to determine, by the first network device, whether the control MAC address of the control packet matches a MAC address of the first network device.

When it is determined that the control MAC address of the control packet matches a MAC address of the first network device, processor 152a may execute loop detector 164 to determine, by the first network device, that the match is indicative of the loop. In some aspects, processor 152a may execute loop detector 164 to determine that the loop affects one or more VLANs running on the network on the network.

Processor 152a may execute port blocker 166 to block, by the first network device, a port of the first network device that the control packet arrived on without blocking any other ports on the first network device, wherein no ports are blocked on other devices on the network that received the control packet. In some aspects, Processor 152a may execute port blocker 166 to block one or more VLANs on the first port without blocking any additional VLANS from the plurality of VLANS on the first port.

When it is determined that the control MAC address of the control packet does not match the MAC address of the first network device, Processor 152a may execute the port blocker 166 to transmit the control packet to a second network device on the network without blocking any port on the first network device that received the control packet.

Turning again to FIG. 1A, an example configuration causing a network loop is discussed. Of course, this is just one sample simplified configuration of system 100 for explanation purposes and other configurations may be used. In this example configuration, device 110 and device 112 are access switches connected to each other with L2 link (113), which is forming a loop in network. Additionally, the example configuration includes two VLANs, VLAN 1 and VLAN 2. Both VLAN 1 and 2 may be allowed on both MCLAGS 114 and 116 and VLAN 1 is only allowed on the link 113 between 2 accesses switches. This will form a loop for VLAN 1, but not for VLAN 2. Accordingly, device 110 may transmit a loop avoidance packet into the network. The loop avoidance packet may include a control MAC address identifying the device where the control packet originated (in this case the device 110).

The loop avoidance packet may be transmitted across the system 100 and eventually packet receiver 160 of the device 110 may receive the loop avoidance packet. MAC determiner 162 of the device 110 may determine that the control MAC address of the control packet matches the MAC address of the device 110. Accordingly, the loop detector 164 of device 110 may determine that the match is indicative of a network loop and a port blocker 166 of device 110 may block a port of the first network device that the control packet arrived to certain types of traffic without blocking any other ports on the first network device. Specifically, the port may be blocked to traffic corresponding to VLAN 1, where the loop was detected, but the port may not be blocked to traffic corresponding to VLAN 2, where no loop was detected. Therefore, the port of device 110 that received the loop avoidance traffic is not fully blocked for all VLANs, just the VLAN corresponding to the detected loop. Moreover, no ports are blocked on other devices on the network (104, 106, 112) that received the loop avoidance packet.

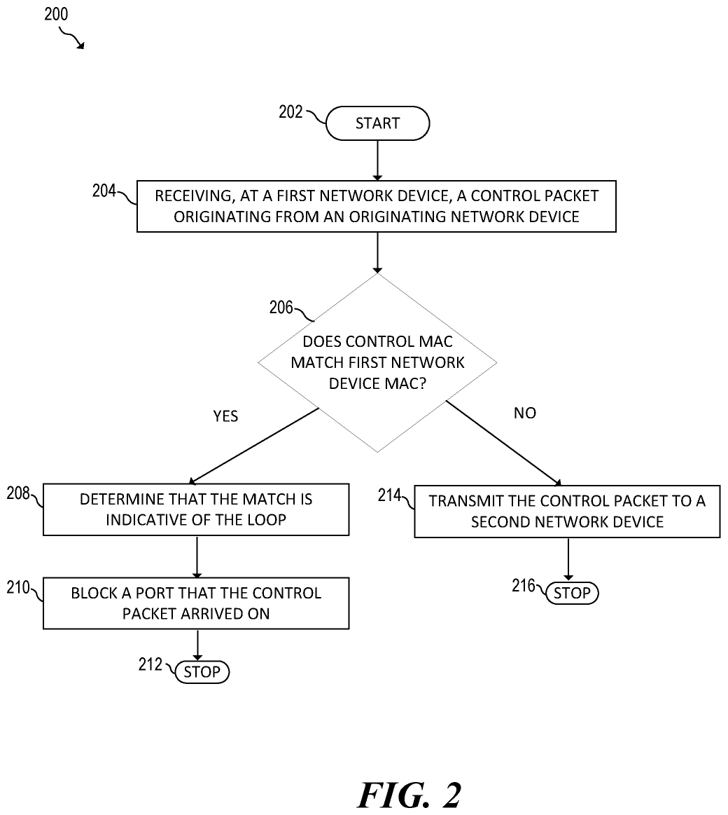

FIG. 2 is a flow diagram of a method 200 for using a loop avoidance protocol. The system where method 200 is performed may be similar to system 100 described above. Accordingly, parts of and/or the entire method may be performed by one or more of the devices belonging to system 100. The method 200 may begin at block 202 and proceed to block 204, where the method may include receiving, at a first network device, a control packet originating from a originating network device. The control packet may have a control MAC address identifying the originating network device and the control packet may be used for determining a traffic loop in a network including the first network device and the originating network device. The control MAC address may be associated with a specific vendor. The first network device may be an uplink network switch. The control packet may be a Rapid Per-ULAN Spanning Tree (RPVST) packet. The first network device and a second network device may be part of a link aggregation group.

At block 206, the method may include determining, by the first network device, whether the control MAC address of the control packet matches a MAC address of the first network device. If it is determined that the control MAC address of the control packet matches a MAC address of the first network device (YES branch of block 206), the method may proceed to block 208, where the method may include determining, by the first network device, that the match is indicative of the loop. The method may proceed to block 210, where the method may include blocking, by the first network device, a port of the first network device that the control packet arrived on without blocking any other ports on the first network device, wherein no ports are blocked on other devices on the network that received the control packet. The method may proceed to block 212, where the method may end.

If it is determined that the control MAC address of the control packet does not match a MAC address of the first network device (NO branch of block 206), the method may proceed to block 214, where the method may include determining, by the first network device, whether the control MAC address of the control packet matches a MAC address of the first network device. The method may proceed to block 216, where the method may end.

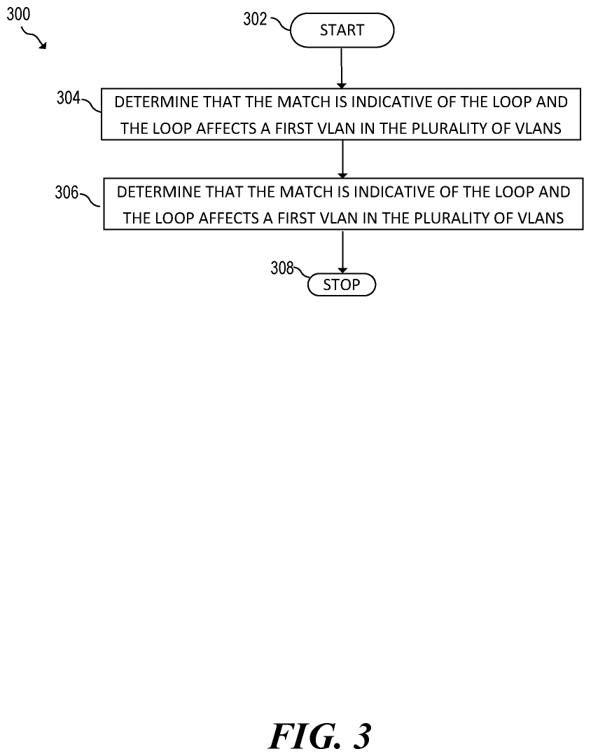

FIG. 3 is a flow diagram of another method 300 for using a loop avoidance protocol. The system where method 300 is performed may be similar to system 100 described above. Accordingly, parts of and/or the entire method may be performed by one or more of the devices belonging to system 100. In some aspects, a plurality of VLANs are active on the network where the method 300 is performed. In these aspects, the method 300 may begin at block 302 and proceed to block 304, where the method may include determining that the match is indicative of the loop and the loop affects a first VLAN in the plurality of VLANs on the network when it is determined that the control MAC address of the control packet matches the MAC address of the first network device. The method may proceed to block 306, where the method may include blocking the port of the first network device that the control packet arrived on, including, blocking the first VLAN on the first port without blocking any additional VLANS from the plurality of VLANS on the first port. The method may proceed to block 308, where the method may end.

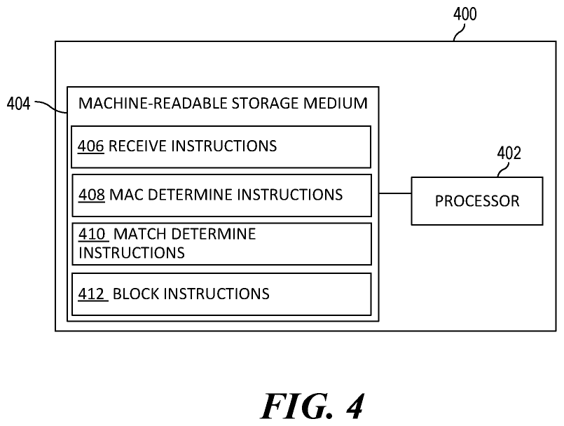

FIG. 4 is a block diagram of an example system 400 using a loop avoidance protocol. In the example illustrated in FIG. 4, system 400 includes a processor 402 and a machine-readable storage medium 404. In some aspects, processor 402 and machine-readable storage medium 404 may be part of an Application-specific integrated circuit (ASIC). Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 402 may be at least one central processing unit (CPU), microprocessor, and/or other hardware devices suitable for retrieval and execution of instructions stored in machine-readable storage medium 404. In the example illustrated in FIG. 4, processor 402 may fetch, decode, and execute instructions 406, 408, 410 and 412. Processor 402 may include at least one electronic circuit comprising a number of electronic components for performing the functionality of at least one of the instructions in machine-readable storage medium 404. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 404 may be any electronic, magnetic, optical, or other physical storage device that stores executable instructions. Thus, machine-readable storage medium 404 may be, for example, Random Access Memory (RAM), an Electrically-Erasable Programmable Read-Only Memory (EEPROM), a storage drive, an optical disc, and the like. Machine-readable storage medium 404 may be disposed within system 400, as shown in FIG. 4. In this situation, the executable instructions may be “installed” on the system 400. Machine-readable storage medium 404 may be a portable, external or remote storage medium, for example, that allows system 400 to download the instructions from the portable/external/remote storage medium. In this situation, the executable instructions may be part of an “installation package”. As described herein, machine-readable storage medium 404 may be encoded with executable instructions for context aware data backup. The machine-readable storage medium may be non-transitory.

Referring to FIG. 4, receive instructions 406, when executed by a processor (e.g., 402), may cause system 400 to receive, at a first network device, a control packet originating from a originating network device, wherein the control packet has a control MAC address identifying the originating network device and the control packet is used for determining a traffic loop in a network including the first network device and the originating network device.

The control MAC address may be associated with a specific vendor. The first network device may be an uplink network switch. The control packet may be a Rapid Per-′ALAN Spanning Tree (RPVST) packet. The first network device and a second network device may be part of a link aggregation group.

MAC determine instructions 408, when executed by a processor (e.g., 402), may cause system 400 to determine, by the first network device, whether the control MAC address of the control packet matches a MAC address of the first network device.

Match determine instructions 410, when executed by a processor (e.g., 402), may cause system 400 to, when it is determined that the control MAC address of the control packet matches a MAC address of the first network device, determine, by the first network device, that the match is indicative of the loop.

In some aspects, match determine instructions 410, when executed by a processor (e.g., 402), may cause system 400 to, when it is determined that the control MAC address of the control packet does not match the MAC address of the first network device, transmit the control packet to a second network device on the network without blocking any port on the first network device that received the control packet.

Block instructions 412, when executed by a processor (e.g., 402), may cause system 400 to block, by the first network device, a port of the first network device that the control packet arrived on without blocking any other ports on the first network device, wherein no ports are blocked on other devices on the network that received the control packet.

In some aspects, a plurality of VLANs are active on the network. Accordingly, match determine instructions 410, when executed by a processor (e.g., 402), may cause system 400 to determine that the match is indicative of the loop and the loop affects a first VLAN in the plurality of VLANs on the network when it is determined that the control MAC address of the control packet matches the MAC address of the first network device and wherein blocking the port of the first network device that the control packet arrived on comprises. Additionally, block instructions 412, when executed by a processor (e.g., 402), may cause system 400 to block the first VLAN on the first port without blocking any additional VLANS from the plurality of VLANS on the first port.

The foregoing disclosure describes a number of examples for using a loop avoidance protocol. The disclosed examples may include systems, devices, computer-readable storage media, and methods for route updating using a loop avoidance protocol. For purposes of explanation, certain examples are described with reference to the components illustrated in FIGS. 1A-4. The content type of the illustrated components may overlap, however, and may be present in a fewer or greater number of elements and components. Further, all or part of the content type of illustrated elements may co-exist or be distributed among several geographically dispersed locations. Further, the disclosed examples may be implemented in various environments and are not limited to the illustrated examples.

Further, the sequence of operations described in connection with FIGS. 1A-4 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

1. A method comprising
receiving, at a first network device, a control packet originating from a originating network device, wherein the control packet has a control MAC address identifying the originating network device and the control packet is used for determining a traffic loop in a network including the first network device and the originating network device;
determining, by the first network device, whether the control MAC address of the control packet matches a MAC address of the first network device;
wherein, when it is determined that the control MAC address of the control packet matches a MAC address of the first network device,
determine, by the first network device, that the match is indicative of the loop; and
block, by the first network device, a port of the first network device that the control packet arrived on without blocking any other ports on the first network device, wherein no ports are blocked on other devices on the network that received the control packet;
wherein, when it is determined that the control MAC address of the control packet does not match the MAC address of the first network device,
transmit the control packet to a second network device on the network without blocking any port on the first network device that received the control packet.

2. The method of claim 1, wherein a plurality of VLANs are active on the network, the method comprising:
wherein, when it is determined that the control MAC address of the control packet matches the MAC address of the first network device,
determine that the match is indicative of the loop and the loop affects a first VLAN in the plurality of VLANs on the network.

3. The method of claim 2, wherein blocking the port of the first network device that the control packet arrived on comprises:
blocking the first VLAN on the first port without blocking any additional VLANS from the plurality of VLANS on the first port.

4. The method of claim 1 wherein the control MAC address is associated with a specific vendor.

5. The method of claim 1 wherein the first network device is an uplink network switch.

6. The method of claim 1 wherein the control packet is a Rapid Per-VLAN Spanning Tree (RPVST) packet.

7. The method of claim 1 wherein the first network device and a second network device are part of a link aggregation group.

8. A system comprising:
a packet receiver to receive, at a first network device, a control packet originating from a originating network device, wherein the control packet has a control MAC address identifying the originating network device and the control packet is used for determining a traffic loop in a network including the first network device and the originating network device;
a MAC determiner to determine, by the first network device, whether the control MAC address of the control packet matches a MAC address of the first network device;
wherein, when it is determined that the control MAC address of the control packet matches a MAC address of the first network device,
a loop detector to determine, by the first network device, that the match is indicative of the loop; and
a port blocker to block, by the first network device, a port of the first network device that the control packet arrived on without blocking any other ports on the first network device, wherein no ports are blocked on other devices on the network that received the control packet;
wherein, when it is determined that the control MAC address of the control packet does not match the MAC address of the first network device,
the port blocker to transmit the control packet to a second network device on the network without blocking any port on the first network device that received the control packet.

9. The system of claim 8, wherein a plurality of VLANs are active on the network, the loop determiner to:
determine that the match is indicative of the loop and the loop affects a first VLAN in the plurality of VLANs on the network when it is determined that the control MAC address of the control packet matches the MAC address of the first network device.

10. The system of claim 9, wherein blocking the port of the first network device that the control packet arrived on comprises:
blocking the first VLAN on the first port without blocking any additional VLANS from the plurality of VLANS on the first port.

11. The system of claim 8 wherein the control MAC address is associated with a specific vendor.

12. The system of claim 8 wherein the first network device is an uplink network switch.

13. The system of claim 8 wherein the control packet is a Rapid Per-VLAN Spanning Tree (RPVST) packet.

14. The system of claim 8 wherein the first network device and a second network device are part of a link aggregation group.

15. A non-transitory computer-readable storage medium encoded with instructions, the instructions executable by a processor of a system to cause the system to:
receive, at a first network device, a control packet originating from a originating network device, wherein the control packet has a control MAC address identifying the originating network device and the control packet is used for determining a traffic loop in a network including the first network device and the originating network device;
determine, by the first network device, whether the control MAC address of the control packet matches a MAC address of the first network device;
wherein, when it is determined that the control MAC address of the control packet matches a MAC address of the first network device,
determine, by the first network device, that the match is indicative of the loop; and
block, by the first network device, a port of the first network device that the control packet arrived on without blocking any other ports on the first network device, wherein no ports are blocked on other devices on the network that received the control packet.

16. The non-transitory computer-readable storage medium of claim 15, wherein a plurality of VLANs are active on the network, the instructions executable by a processor of a system to cause the system to:
determine that the match is indicative of the loop and the loop affects a first VLAN in the plurality of VLANs on the network when it is determined that the control MAC address of the control packet matches the MAC address of the first network device and wherein blocking the port of the first network device that the control packet arrived on comprises:
blocking the first VLAN on the first port without blocking any additional VLANS from the plurality of VLANS on the first port.

17. The non-transitory computer-readable storage medium of claim 15 wherein the control MAC address is associated with a specific vendor.

18. The non-transitory computer-readable storage medium of claim 15 wherein the first network device is an uplink network switch.

19. The non-transitory computer-readable storage medium of claim 15 wherein the control packet is a Rapid Per-VLAN Spanning Tree (RPVST) packet.

20. The non-transitory computer-readable storage medium of claim 15 wherein the first network device and a second network device are part of a link aggregation group.
